(19) United States
(12) Patent Application Publication
(10) Pub. No.: US 2026/0034877 A1
(43) Pub. Date: Feb. 5, 2026

(54) INTEGRATED AUXILIARY FUEL OIL TANK FOR VEHICLE

(71) Applicants: WUXI YILI ENVIRONMENTAL PROTECTION TECHNOLOGY CO., LTD, WUXI (CN); HEBEI YILI TECHNOLOGY CO., LTD, XINGTAI (CN)

(72) Inventors: LIYI YIN, WUXI (CN); CHUANG ZHAO, WUXI (CN); JINLING ZHANG, WUXI (CN); XIANGMIN LIU, WUXI (CN)

(21) Appl. No.: 19/356,106

(22) Filed: Oct. 11, 2025

Related U.S. Application Data
(63) Continuation of application No. PCT/CN2023/116727, filed on Sep. 4, 2023.

(30) Foreign Application Priority Data
Apr. 11, 2023 (CN) 202310381839.3

(51) Int. Cl. B60K 15/063; B60K 15/01; B60K 15/03

(52) U.S. Cl. CPC B60K 15/063; B60K 15/01; B60K 2015/03217; B60K 2015/03236; B60K 2015/03243; B60K 2015/03296; B60K 2015/03368; B60K 2015/03427

(57) ABSTRACT

The present invention provides an integrated auxiliary fuel oil tank for a vehicle, which structurally includes a fuel oil tank body, wherein a gear pump assembly and a coarse filter are mounted on the inner side of the fuel oil tank body, and a fuel oil suction passage passing through the coarse filter and a fuel oil return pipeline are arranged between the fuel oil tank body and an engine fuel oil system. The gear pump assembly is provided with a first passage during forward rotation, and a fuel oil filling passage is arranged between the main fuel oil tank of the vehicle and the fuel oil tank body. The gear pump assembly is further provided with a second passage during reverse rotation, and an active fuel oil supply passage is further arranged between the fuel oil tank body and the engine fuel oil system.

### FIELD OF THE INVENTION

The present invention relates to an integrated auxiliary fuel oil tank for a vehicle, and more particularly, to an integrated auxiliary fuel oil tank for heavy vehicles such as engineering vehicles and medium and heavy trucks, belonging to the technical field of fuel oil tanks for vehicles.

### BACKGROUND OF THE INVENTION

In view of a main fuel oil tank for a four-wheel vehicle, due to its large volume, there is a possibility that a fuel oil suction port may leave from a liquid level of fuel oil in the event of road bumps or long uphill and downhill sections when the liquid level is at a relatively low position, such that air is conveyed to an engine, thereby affecting the stability of continuous supply of fuel oil. This problem is solved by considering that an auxiliary fuel oil tank which has a small volume and is communicated with the main fuel oil tank is used to supply fuel oil.

Although a heavy vehicle is generally equipped with two fuel oil tanks, they are only used to reduce the number of fuel oil filling or facilitate fleet management. Two fuel oil tanks of a dual-fuel-oil-tank heavy vehicle in the prior art are generally mounted at different positions, and are communicated with each other through a pipeline (e.g., CN204267196U), which occupy a large amount of space, and cannot solve the problem of insufficient stability during continuous supply of fuel oil at the above-mentioned low liquid level.

On the other hand, dual fuel oil tanks or dual-chamber fuel oil tanks are used in the prior art to solve the problem that high-grade diesel in low-temperature areas becomes thick and forms wax, making it impossible to use normally (e.g., CN209875341U). The two fuel oil tanks are respectively filled with high- and low-grade diesel, wherein the low-grade diesel is used for starting a vehicle, while the high-grade diesel is used for mid-way use. Moreover, a heating mechanism is provided for the high-grade diesel. However, two grades of fuel oil need to be filled, which leads to cumbersome use, and cannot solve the problem of insufficient stability during continuous supply of fuel oil at the low liquid level.

A coarse filter is an important component of a fuel oil system. In the prior art, coarse filters are sometimes placed outside fuel oil tanks, and there are also designs where an integrated fuel oil tank is provided (e.g., CN214083849U). However, a filter core mounting port is generally formed at the upper part, which is inconvenient for maintenance and cleaning, and is less versatile since it is generally only adapted to one type of filter core (top-in and top-out or top-in and bottom-out).

### SUMMARY OF THE INVENTION

The present invention proposes an integrated auxiliary fuel oil tank for a vehicle, which aims to overcome the aforementioned defects of the prior art and achieve continuous and stable supply of fuel oil at a low liquid level, and can cope with low-temperature environments just by filling one grade of fuel oil, while simplifying the maintenance of a coarse filter and improving the versatility.

A technical solution of the present invention is as follows: an integrated auxiliary fuel oil tank for a vehicle includes a fuel oil tank body which is mounted on a side of a main fuel oil tank of the vehicle and has a volume smaller than that of the main fuel oil tank of the vehicle, in which a gear pump assembly and a coarse filter are mounted on the inner side of the fuel oil tank body; a fuel oil suction passage passing through the coarse filter is arranged between the fuel oil tank body and an engine fuel oil system; the fuel oil tank body is further communicated with the engine fuel oil system through a fuel oil return pipe; the gear pump assembly is provided with a first passage during forward rotation; and a fuel oil filling passage passing through the first passage of the gear pump assembly is arranged between the main fuel oil tank of the vehicle and the fuel oil tank body. Fuel oil is supplied to the auxiliary fuel oil tank, having the volume smaller than that of the main fuel oil tank of the vehicle, through the main fuel oil tank of the vehicle, and then to the engine fuel oil system through the auxiliary fuel oil tank, so continuous and stable supply of fuel oil can be effectively achieved, and the suction of air at a low liquid level can be avoided.

Preferably, the gear pump assembly is further provided with a second passage during reverse rotation, and an active fuel oil supply passage passing through the second passage of the gear pump assembly and the coarse filter is further arranged between the fuel oil tank body and the engine fuel oil system. Active supply of fuel oil to the engine fuel oil system can be achieved under special working conditions.

Preferably, an outlet of the coarse filter is externally connected to the engine fuel oil system through a fuel oil outlet passage via a pipeline; an inlet of the coarse filter is communicated with an engine fuel oil suction passage; the engine fuel oil suction passage extends from the inlet of the coarse filter close to the top end of the fuel oil tank body vertically to a part on the inner side of the fuel oil tank body close to the bottom end; a check valve A is arranged at a part of the engine fuel oil suction passage close to the bottom end; and the fuel oil suction passage is formed by the engine fuel oil suction passage passing through the check valve A and the coarse filter. The engine fuel oil system actively sucks oil from the fuel oil tank body.

Preferably, a fuel oil replenishing passage extends from the top end of the fuel oil tank body vertically to the gear pump assembly; a port at the top end of the fuel oil replenishing passage is externally connected to a fuel oil outlet at the bottom of the main fuel oil tank of the vehicle through a pipeline; the bottom end of the fuel oil replenishing passage is communicated with a first inlet/outlet of the gear pump assembly; a check valve B is arranged at the bottom end of the fuel oil replenishing passage; an intermediate fuel oil passage extends from the gear pump assembly vertically to a part on the inner side of the fuel oil tank body close to the bottom end; the top end of the intermediate fuel oil passage is communicated with a second inlet/outlet of the gear pump assembly, and the bottom end of the intermediate fuel oil passage is communicated with the inner side of the fuel oil tank body; the first passage of the gear pump assembly is formed by the first inlet/outlet to the second inlet/outlet of the gear pump assembly; and the fuel oil filing passage is formed by the fuel oil suction passage above the check valve B, the first passage of the gear pump assembly and the intermediate fuel oil passage. The main fuel oil tank of the vehicle supplies fuel oil to the fuel oil tank body. An overflow port is formed in the top end of the fuel oil tank body; and the overflow port is communicated with the main fuel oil tank of the vehicle through an overflow pipe, which prevents fuel oil from being replenished excessively.

Preferably, a third inlet/outlet of the gear pump assembly is communicated with the engine fuel oil suction passage above the check valve A; a pressure opening valve is arranged at the third inlet/outlet of the gear pump assembly; and the active fuel oil supply passage is formed by the second passage of the gear pump assembly of the intermediate fuel oil passage, the engine fuel oil suction passage above the pressure opening valve and the coarse filter. The fuel oil tank body actively supplies fuel oil to the engine fuel oil system.

Preferably, in order to achieve effective heating of fuel oil and cope with a low-temperature environment, an electric heating mechanism is fixed at the top end of the fuel oil tank body; the electric heating mechanism includes an L-shaped electric heating pipe which extends from the top end in the fuel oil tank body to a part in the fuel oil tank body close to the bottom end, and extends from a part in the fuel oil tank body close to the bottom end horizontally to inlets at the bottom end of the engine fuel oil suction passage and the bottom end of the intermediate fuel oil passage; and the electric heating mechanism further includes a temperature sensor mounted in the fuel oil tank body.

Preferably, in order to achieve intelligent and automatic control over various working conditions, a float level gauge which extends from a part in the fuel oil tank body close to the bottom end is fixed at the top end of the fuel oil tank body; the float level gauge is provided with a high liquid level point and a low liquid level point; the float level gauge is in signal connection with a control module; and the control module is also in signal connection with the gear pump assembly, the L-shaped electric heating pipe and the temperature sensor.

Preferably, in order to achieve mounting and fixing of the fuel oil tank body and the main fuel oil tank of the vehicle, the fuel oil tank body is integrally formed on and connected to one side of a mounting plate body, and the other side of the mounting plate body is mounted on a side of the main fuel oil tank of the vehicle. For convenience of mounting, the fuel oil tank body on four corners of the mounting plate body are recessed inward, and the four corners of the mounting plate body are respectively provided with mounting screw holes, and during mounting, are fixedly mounted with the main fuel oil tank of the vehicle through screws that pass through the mounting screw holes. In order to prevent damages during transportation, surface structures of the fuel oil tank body are all retracted to the edge of the mounting plate body. In order to specifically achieve the mounting of the gear pump assembly, a gear pump mounting groove is integrally formed in the lower part on the inner side of the fuel oil tank body; an opening of the gear pump mounting groove is formed in the other side of the mounting plate body; and the gear pump assembly is mounted in the gear pump mounting groove.

Preferably, the coarse filter includes a coarse filter mounting groove which is integrally formed in the fuel oil tank body on one side of the gear pump mounting groove; a coarse filter core is mounted in the coarse filter mounting groove; and the coarse filter mounting groove is tilted, so the space utilization rate can be increased, making the structure compact. An opening of the coarse filter mounting groove is located in the lower part on one side of the fuel oil tank body; and an end cover is mounted at the opening of the coarse filter mounting groove. The design of downward tilting and the opening being located at the lower part on the outer side makes it convenient for maintenance, replacement of a filter core, and drainage of wastewater during cleaning. A fuel oil outlet passage A and a fuel oil outlet passage B which are erected are integrally formed at the top end of the coarse filter mounting groove and a part of the coarse filter mounting groove close to the bottom end on the outer side, respectively, as two fuel oil outlet passages. A port at the top end of the fuel oil outlet passage A or the fuel oil outlet passage B is externally connected to the engine fuel oil system through a pipeline. Two filter cores (top-in and top-out or top-in and bottom-out) may be mounted in the coarse filter mounting groove to adapt to the requirements of different engines.

A method for controlling an integrated auxiliary fuel oil tank for a vehicle includes the following steps:
when it is necessary to actively supply fuel oil to the engine fuel oil system from the fuel oil tank body, the gear pump assembly is reversed, wherein the fuel oil is fed from the second inlet/outlet and discharged from the third inlet/outlet; the check valve A and the check valve B are closed, and the pressure opening valve is opened, wherein the fuel oil sequentially flows through the intermediate fuel oil passage, the gear pump assembly, the pressure opening valve, the engine fuel oil suction passage and the coarse filter into the engine fuel oil system;
when the vehicle is driving normally and the fuel oil in the fuel oil tank body is sufficient, that is, when the float level gauge does not reach the low liquid level point, the engine fuel oil system actively sucks the fuel oil, and the gear pump assembly does not work; the check valve A is opened, and the check valve B and the pressure opening valve are closed, wherein the fuel oil sequentially flows through the engine fuel oil suction passage and the coarse filter and is then conveyed into the engine fuel oil system; and
when the vehicle is driving normally but the fuel oil in the fuel oil tank body is insufficient, that is, when the float level gauge reaches the low liquid level point, the fuel oil is replenished from the main fuel oil tank of the vehicle; the gear pump assembly rotates forward, wherein the fuel oil is fed from the first inlet/outlet and discharged from the second inlet/outlet; and the check valve A is opened, the pressure opening valve is closed, and the check valve B is opened, wherein the replenished fuel oil is conveyed from the main fuel oil tank of the vehicle, and sequentially flows through the fuel oil replenishing passage, the check valve B, the gear pump assembly, and the intermediate fuel oil passage into the fuel oil tank body until the float level gauge reaches the high liquid level point.

The present invention has the following advantages:
1) the integrated structure design omits a large number of pipelines, which can effectively reduce faults;
2) the properly designed auxiliary fuel oil tank can effectively solve the problem of insufficient stability during continuous supply of fuel oil when the main fuel oil tank is at a low liquid level, and ensure continuous and stable supply of fuel oil;
3) through one body, the main fuel oil tank can supply fuel oil to the auxiliary fuel oil tank at the same time, and the auxiliary fuel oil tank can actively pump fuel oil to the fuel oil system under special working conditions, achieving comprehensive functions;
4) the reasonably designed coarse filter structure can meet the mounting of a variety of coarse filters, and is easy to maintain and clean;
5) the reasonably designed electric heating structure is capable of coping with low-temperature working conditions; and
6) the liquid level gauge can achieve automatic control, and meet the requirements for automated operations such as overall oil replenishment and oil delivery.

### BRIEF DESCRIPTION OF THE DRAWINGS

FIG. 1 is a schematic structural diagram of an integrated auxiliary fuel oil tank for a vehicle in the present invention.

FIG. 2 is a main view of FIG. 1.

FIG. 3 is a rear view of FIG. 2.

FIG. 4 is a sectional view of FIG. 2.

FIG. 5 is a schematic diagram of an integrated auxiliary fuel oil tank for a vehicle in the present invention.

FIG. 6 is a schematic diagram of a working state in Embodiment 1 of the present invention.

FIG. 7 is a schematic diagram of a working state in Embodiment 2 of the present invention.

FIG. 8 is a schematic diagram of a working state in Embodiment 3 of the present invention.

Reference symbols represent the following components: 1—mounting plate body; 11—mounting screw hole; 2—fuel oil tank body; 21—engine fuel oil suction passage; 211—check valve A; 22—intermediate fuel oil passage; 23—fuel oil replenishing passage; 231—check valve B; 24—fuel oil tank cover with breathing valve; 25—auxiliary accommodating cavity; 26—fuel oil discharge bolt; 3—gear pump assembly; 31—pressure opening valve; 4—coarse filter mounting groove; 41—end cover; 42—fuel oil outlet passage A; 43—fuel oil outlet passage B; 44—air-permeable balance valve; 5—L-shaped electric heating pipe; 6—float level gauge; 7—fuel oil return pipe; and 8—overflow port.

### DETAILED DESCRIPTION OF SOME EMBODIMENTS

The present invention will be further described below in conjunction with the embodiments and detailed description.

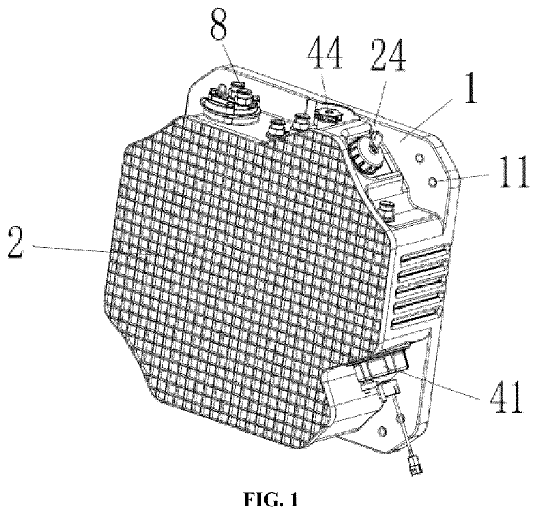

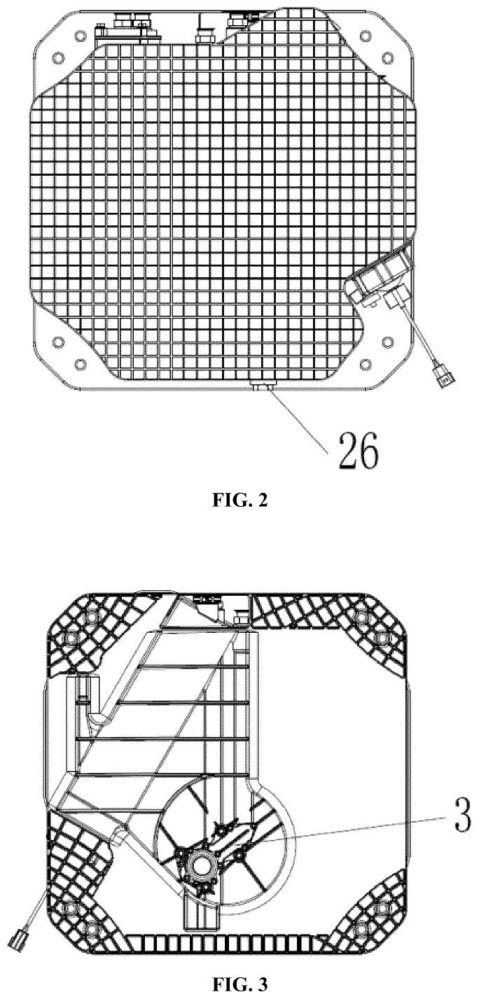

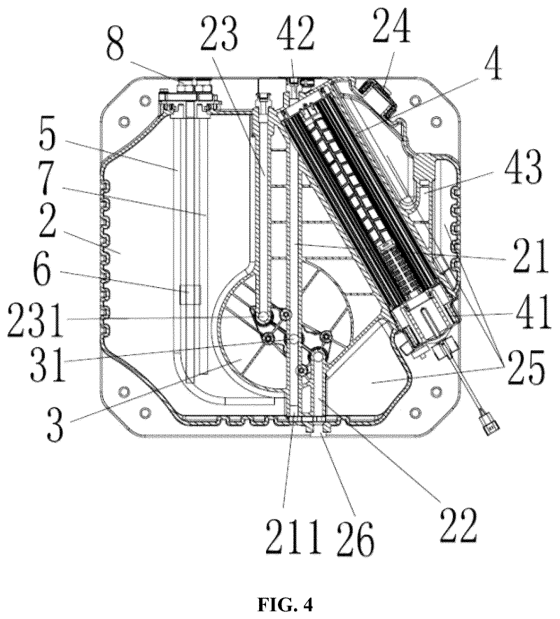

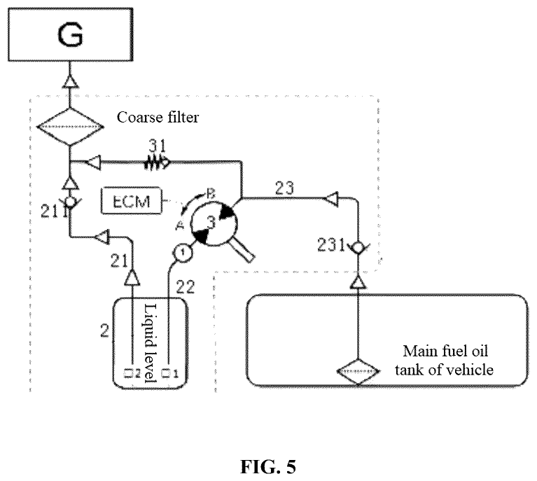

As shown in FIGS. 1-5, an integrated auxiliary fuel oil tank for a vehicle structurally includes a mounting plate body 1 and a fuel oil tank body 2 which are integrally formed, wherein the fuel oil tank body 2 is arranged on a side of the mounting plate body 1, and the mounting plate body 1 is mounted on a side of a main fuel oil tank of a vehicle.

For convenience of mounting, the fuel oil tank body 2 on four corners of the mounting plate body 1 are recessed inward, and the four corners of the mounting plate body 1 are respectively provided with mounting screw holes 11, and during mounting, are fixedly mounted with the main fuel oil tank of the vehicle through screws that pass through the mounting screw holes 11.

A gear pump mounting groove is integrally formed in the lower part on the inner side of the fuel oil tank body 2; an opening of the gear pump mounting groove is formed in the other side of the mounting plate body 1; and the gear pump assembly 3 is mounted in the gear pump mounting groove.

A coarse filter mounting groove 4 is integrally formed in the fuel oil tank body 2 on one side of the gear pump mounting groove; a coarse filter core is mounted in the coarse filter mounting groove 4 to form the coarse filter; and the coarse filter mounting groove is tilted, so the space utilization rate can be increased, making the structure compact. An opening of the coarse filter mounting groove 4 is located in the lower part on one side of the fuel oil tank body 2; and an end cover 41 is mounted at the opening of the coarse filter mounting groove 4. The design of downward tilting and the opening being located at the lower part on the outer side makes it convenient for maintenance, replacement of a filter core, and drainage of wastewater during cleaning. As a standard structure of the prior art, a transparent water collection cup is mounted at the lower end of the coarse filter, an electric heater and a water level sensor are arranged in the water collection cup, and a water discharge valve is arranged at the lower end of the water collection cup. The air-permeable balance valve 44 is also arranged at the top end of the coarse filter for easy maintenance.

A fuel oil outlet passage A 42 and a fuel oil outlet passage B 43 which are erected are integrally formed at the top end of the coarse filter mounting groove 4 and a part of the coarse filter mounting groove close to the bottom end on the outer side, respectively, as two fuel oil outlet passages. The fuel oil inlet passage is arranged at the top end of the engine fuel oil suction passage 21. The engine fuel oil suction passage 21 extends from the top end on the inner side of the coarse filter mounting groove 4 close to the top end of the fuel oil tank body 2 vertically to a part on the inner side of the fuel oil tank body 2 close to the bottom end. A port at the top end of the fuel oil outlet passage A 42 or the fuel oil outlet passage B 43 is externally connected to the engine fuel oil system through a pipeline. Two filter cores (top-in and top-out or top-in and bottom-out) may be mounted in the coarse filter mounting groove 4 to adapt to the requirements of different engines. The fuel oil is fed from the bottom end of the engine fuel oil suction passage 21 and discharged from the top end of the engine fuel oil suction passage 21 into the coarse filter mounting groove 4. If the filter core is a top-in and top-out filter core, the fuel oil is conveyed into the engine fuel oil system through the fuel oil outlet passage A 42. If the filter core is a top-in and bottom-out filter core, the fuel oil is conveyed into the engine fuel oil system through the fuel oil outlet passage B 42. By means of the above structure, the engine fuel oil system actively sucks oil from the fuel oil tank body 2, and the gear pump assembly 3 does not work. A check valve A 211 is arranged at a part of the engine fuel oil suction passage 21 close to the bottom end, and the check valve A 211 is opened when the engine fuel oil system sucks fuel oil from the fuel oil tank body 2.

A fuel oil replenishing passage 23 extends from the top end of the fuel oil tank body 2 vertically to the gear pump mounting groove; a port at the top end of the fuel oil replenishing passage 23 is externally connected to a fuel oil outlet at the bottom of the main fuel oil tank of the vehicle (originally communicated with the engine fuel oil system) through a pipeline; the bottom end of the fuel oil replenishing passage 23 is communicated with a first inlet/outlet of the gear pump assembly 3; a check valve B 231 is arranged at the bottom end of the fuel oil replenishing passage 23; an intermediate fuel oil passage 22 extends from the gear pump mounting groove vertically to a part on the inner side of the fuel oil tank body 2 close to the bottom end; and the top end of the intermediate fuel oil passage 22 is communicated with a second inlet/outlet of the gear pump assembly 3, and the bottom end of the intermediate fuel oil passage 22 is communicated with the inner side of the fuel oil tank body 2. By means of the above structure, the main fuel oil tank of the vehicle replenishes fuel oil to the auxiliary fuel oil tank (i.e., the fuel oil tank body 2). When the fuel oil is replenished, the check valve B 231 is opened, and the gear pump assembly 3 works. In this passage, the fuel oil is fed from the first inlet/outlet and discharged from the second inlet/outlet. The fuel oil flows from the top end of the fuel oil replenishing passage 23 to the bottom end, pumped in from the first inlet/outlet of the gear pump assembly 3 and outlet from the second inlet/outlet, and fed from the top end of the intermediate fuel oil passage 22 and discharged from the bottom end, and then flows into the fuel oil tank body 2. In this case, the engine fuel oil system generally still sucks fuel oil from the fuel oil tank body 2, so the check valve A 211 remains open.

In special circumstances, the auxiliary fuel oil tank needs to supply fuel oil to the engine fuel oil system through the gear pump assembly 3, the third inlet/outlet of the gear pump assembly 3 is communicated with the engine fuel oil suction passage 21 above the check valve A 211, and the pressure opening valve 31 is arranged at the third inlet/outlet of the gear pump assembly 3. During the supply of fuel oil, the gear pump assembly 3 works, the check valve A 211 is closed, and the pressure opening valve 31 is opened just in this case. In this passage of the gear pump assembly 3, the fuel oil is pumped in from the second inlet/outlet and out from the third inlet/outlet. The check valve B 231 is closed. The fuel oil is fed from the bottom end of the intermediate fuel oil passage 22 and discharged from the top end thereof, flows into the second inlet/outlet of the gear pump assembly 3 and out of the third inlet/outlet, flows into the engine fuel oil passage 21, and is conveyed upward to the engine fuel oil system through the coarse filter.

As a basic structure, a fuel oil return pipe 7 whose bottom end extends to a part in the fuel oil tank body 2 close to the bottom end is fixed at the top end of the fuel oil tank body 2, and the fuel oil return pipe 7 is externally connected to the engine fuel oil system and used for an engine to return fuel oil (when the engine is running, the fuel oil is continuously returned because the amount of fuel oil supplied to the engine fuel oil system is greater than a required mount, resulting in fuel oil return) An overflow port 8 that overflows excessive fuel oil to the main fuel oil tank of the vehicle is formed at the top of the fuel oil tank body 2; and the overflow port 8 is externally connected to the main fuel oil tank of the vehicle through an overflow pipe. A liquid discharge bolt 26 is also arranged at the bottom of the fuel oil tank body 2 for easy cleaning.

In order to achieve effective heating of fuel oil and cope with a low-temperature environment, an electric heating mechanism is fixed at the top end of the fuel oil tank body 2; the electric heating mechanism includes an L-shaped electric heating pipe 5 which extends from the top end in the fuel oil tank body 2 to a part in the fuel oil tank body close to the bottom end, and extends from a part in the fuel oil tank body 2 close to the bottom end horizontally to inlets at the bottom end of the engine fuel oil suction passage 21 and the bottom end of the intermediate fuel oil passage 22; and the electric heating mechanism further includes a temperature sensor mounted in the fuel oil tank body 2. Compared with water bath heating with hysteresis, electric heating has the advantage of fast and stable heating. The temperature sensor monitors a fuel oil temperature inside the fuel oil tank body 2 in real time, and automatically controls the heating of the fuel oil tank body 2 according to a set temperature.

In order to fill a part of the fuel oil into the fuel oil tank body 2 while leaving the factory without waiting for the delivery from the main fuel oil tank of the vehicle, and without affecting the normal operation of the engine, the fuel oil tank cover 42 with a breathing valve is arranged at the top of the fuel oil tank body 2, such that the fuel oil can be filled to ensure the pressure balance.

In order to achieve intelligent and automatic control over various working conditions, a float level gauge 6 which extends from a part in the fuel oil tank body 2 close to the bottom end is fixed at the top end of the fuel oil tank body 2; the float level gauge 6 is provided with a high liquid level point and a low liquid level point; the float level gauge 6 is in signal connection with a control module; and the control module is also in signal connection with the gear pump assembly 3, the L-shaped electric heating pipe 5 and the temperature sensor. To provide a detailed description of various working conditions, the following embodiments are used for illustration.

In order to prevent damages during transportation, the fuel oil tank cover 24 with the breathing valve, both ends of the coarse filter mounting groove 4, the port at the top end of the fuel oil return pipe 7, the overflow port 8, the port at the top end of the fuel oil outlet passage A 42 and the port at the top end of the fuel oil outlet passage B 43 are all retracted to the edge of the mounting plate body 1.

The check valve A 211, the check valve B 231 and the pressure opening valve 31 are all mechanical structures, and their opening and closing states are automatically switched by pressure and do not need to be controlled by a control system.

To ensure the stability of the liquid level within the fuel oil tank body 2 in all aspects, during the specific design, in addition to main accommodating cavities on one side of the gear pump assembly 3 and on one side of the coarse filter, a secondary accommodating cavity 25 communicated with the corresponding main accommodating cavity is respectively arranged at the lower part between the gear pump assembly 3 and the coarse filter, as well as on the other side of the coarse filter, which helps to disperse the fuel oil as much as possible and contributes to the stability of the liquid level.

### Embodiment 1

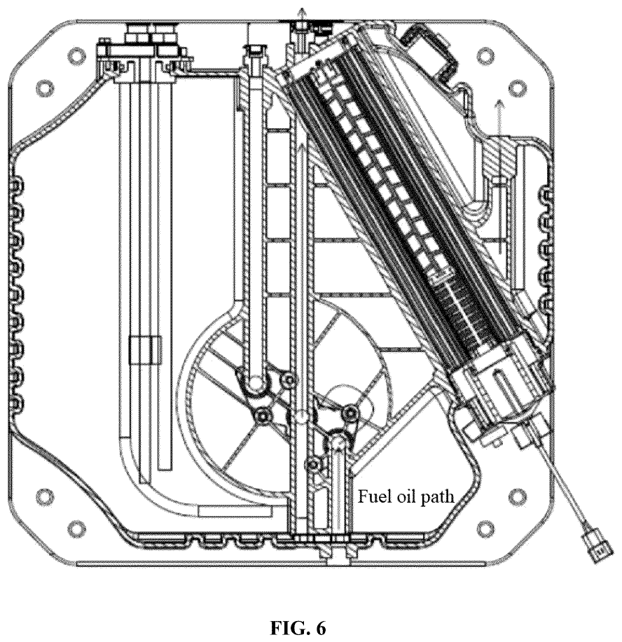

As shown in FIG. 6, when the vehicle is in a special operating condition, e.g., when a new vehicle is started off the line or after a major maintenance of a fuel oil system, a small fuel oil tank (a fuel oil tank body 2) needs to actively supply fuel oil to an engine fuel oil system.

The gear pump assembly 3 is reversed, wherein the fuel oil is fed from the second inlet/outlet and discharged from the third inlet/outlet; the check valve A 211 and the check valve B 231 are closed, and the pressure opening valve 31 is opened, wherein the fuel oil sequentially flows through the intermediate fuel oil passage 22, the gear pump assembly 3, the pressure opening valve 31, the engine fuel oil suction passage 21 and the coarse filter into the engine fuel oil system.

### Embodiment 2

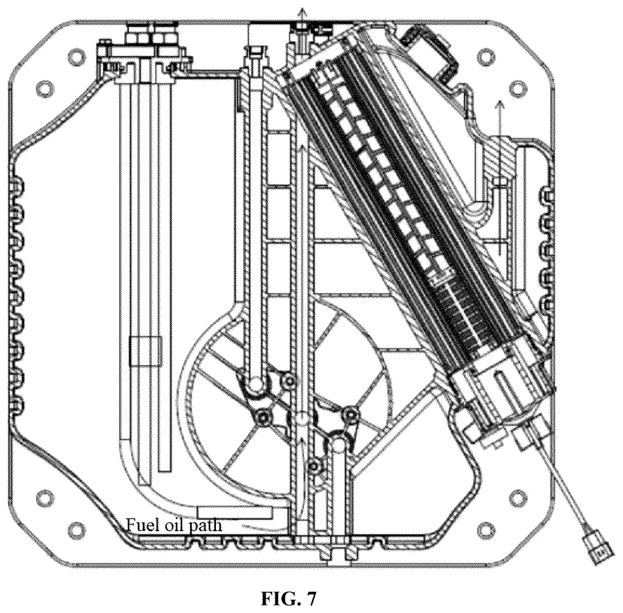

As shown in FIG. 7, when the vehicle is driving normally and the fuel oil in the fuel oil tank body 2 is sufficient, the engine fuel oil system actively sucks fuel oil, without the need to replenish fuel oil from the main fuel oil tank of the vehicle (the float level gauge 6 has not reached a low liquid level point).

The gear pump assembly 3 does not work; the check valve A 211 is opened, and the check valve B 231 and the pressure opening valve 31 are closed; and the fuel oil sequentially flows through the engine fuel oil suction passage 21 and the coarse filter and is then conveyed into the engine fuel oil system.

### Embodiment 3

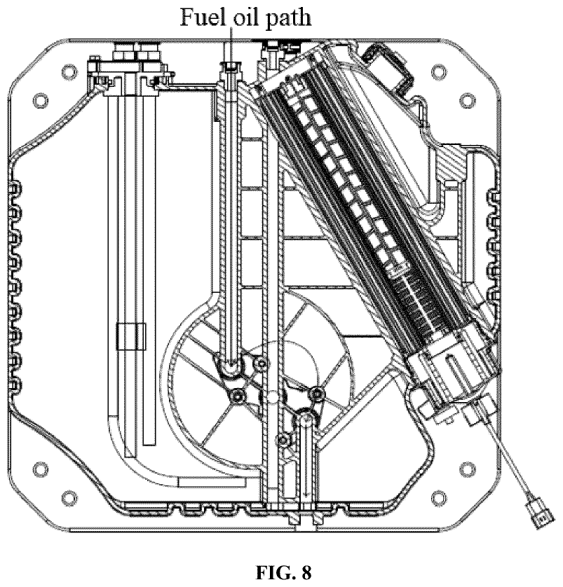

As shown in FIG. 8, when the vehicle is driving normally but the fuel oil in the fuel oil tank body 2 is insufficient, based on Embodiment 2, the fuel oil also needs to be replenished from the main fuel oil tank of the vehicle (the float level gauge 6 has reached a low liquid level point).

The gear pump assembly 3 rotates forward, wherein the fuel oil is fed from the first inlet/outlet and discharged from the second inlet/outlet; and the check valve B 231 is opened, wherein the replenished fuel oil is conveyed from the main fuel oil tank of the vehicle, and sequentially flows through the fuel oil replenishing passage 23, the check valve B 231, the gear pump assembly 3, and the intermediate fuel oil passage 22 into the fuel oil tank body 2 until the float level gauge 6 reaches a high liquid level point and restores to the working state in Embodiment 2.

### Embodiment 4

When the main fuel oil tank of the vehicle is 600 L, the fuel oil tank body 2 is designed to be 30 L, and a fuel oil supply rate is set as 100-480 L/h.

The aforementioned components are all existing technologies, and a person skilled in the art can use any models and existing designs that can achieve their corresponding functions.

The above is only the preferred embodiments of the present invention. For those of ordinary skill in the art, without departing from the inventive concept of the present invention, several modifications and improvements can also be made, and these all fall within the protection scope of the present invention.

What is claimed is:

1. An integrated auxiliary fuel oil tank for a vehicle, comprising a fuel oil tank body (2) which is mounted on a side of a main fuel oil tank of the vehicle and has a volume smaller than that of the main fuel oil tank of the vehicle, wherein a gear pump assembly (3) and a coarse filter are mounted on the inner side of the fuel oil tank body (2); a fuel oil suction passage passing through the coarse filter is arranged between the fuel oil tank body (2) and an engine fuel oil system; the fuel oil tank body (2) is also communicated with the engine fuel oil system through a fuel oil return pipe (7); the gear pump assembly (3) is provided with a first passage during forward rotation; and a fuel oil filling passage passing through the first passage of the gear pump assembly (3) is arranged between the main fuel oil tank of the vehicle and the fuel oil tank body (2).

2. The integrated auxiliary fuel oil tank for the vehicle according to claim 1, wherein the gear pump assembly (3) is further provided with a second passage during reverse rotation, and an active fuel oil supply passage passing through the second passage of the gear pump assembly (3) and the coarse filter is further arranged between the fuel oil tank body (2) and the engine fuel oil system.

3. The integrated auxiliary fuel oil tank for the vehicle according to claim 2, wherein an outlet of the coarse filter is externally connected to the engine fuel oil system through a fuel oil outlet passage via a pipeline; an inlet of the coarse filter is communicated with an engine fuel oil suction passage (21); the engine fuel oil suction passage (21) extends vertically from the inlet of the coarse filter close to the top end of the fuel oil tank body (2) to a part on the inner side of the fuel oil tank body (2) close to the bottom end; a check valve A (211) is arranged at a part of the engine fuel oil suction passage (21) close to the bottom end; and the fuel oil suction passage is formed by the engine fuel oil suction passage (21) passing through the check valve A (211) and the coarse filter.

4. The integrated auxiliary fuel oil tank for the vehicle according to claim 3, wherein a fuel oil replenishing passage (23) extends from the top end of the fuel oil tank body (2) vertically to the gear pump assembly (3); a port at the top end of the fuel oil replenishing passage (23) is externally connected to a fuel oil outlet at the bottom of the main fuel oil tank of the vehicle through a pipeline; the bottom end of the fuel oil replenishing passage (23) is communicated with a first inlet/outlet of the gear pump assembly (3); a check valve B (231) is arranged at the bottom end of the fuel oil replenishing passage (23); an intermediate fuel oil passage (22) extends from the gear pump assembly (3) vertically to a part on the inner side of the fuel oil tank body (2) close to the bottom end; the top end of the intermediate fuel oil passage (22) is communicated with a second inlet/outlet of the gear pump assembly (3), and the bottom end of the intermediate fuel oil passage (22) is communicated with the inner side of the fuel oil tank body (2); the first passage of the gear pump assembly (3) is formed by the first inlet/outlet to the second inlet/outlet of the gear pump assembly (3); the fuel oil filing passage is formed by the fuel oil suction passage (21) above the check valve B (231), the first passage of the gear pump assembly (3) and the intermediate fuel oil passage (22); an overflow port (8) is formed in the top end of the fuel oil tank body (2); and the overflow port (8) is communicated with the main fuel oil tank of the vehicle through an overflow pipe.

5. The integrated auxiliary fuel oil tank for the vehicle according to claim 4, wherein a third inlet/outlet of the gear pump assembly (3) is communicated with the engine fuel oil suction passage (21) above the check valve A (211); a pressure opening valve (31) is arranged at the third inlet/outlet of the gear pump assembly (3); and the active fuel oil supply passage is formed by the second passage of the gear pump assembly (3) of the intermediate fuel oil passage (22), the engine fuel oil suction passage (21) above the pressure opening valve (31) and the coarse filter.

6. The integrated auxiliary fuel oil tank for the vehicle according to claim 5, wherein an electric heating mechanism is fixed at the top end of the fuel oil tank body (2); the electric heating mechanism comprises an L-shaped electric heating pipe (5) which extends from the top end in the fuel oil tank body (2) to a part in the fuel oil tank body (2) to the bottom end, and extends from a part in the fuel oil tank body (2) close to the bottom end horizontally to inlets at the bottom end of the engine fuel oil suction passage (21) and the bottom end of the intermediate fuel oil passage (22); and the electric heating mechanism further comprises a temperature sensor mounted in the fuel oil tank body (2).

7. The integrated auxiliary fuel oil tank for the vehicle according to claim 6, wherein a float level gauge (6) which extends to a part in the fuel oil tank body (2) close to the bottom end is fixed at the top end of the fuel oil tank body (2); the float level gauge (6) is provided with a high liquid level point and a low liquid level point; the float level gauge (6) is in signal connection with a control module; and the control module is also in signal connection with the gear pump assembly (3), the L-shaped electric heating pipe (5) and the temperature sensor.

8. The integrated auxiliary fuel oil tank for the vehicle according to claim 1, wherein the fuel oil tank body (2) is integrally formed and connected to one side of a mounting plate body (1), and the other side of the mounting plate body (1) is mounted on a side of the main fuel oil tank of the vehicle; the fuel oil tank body (2) on four corners of the mounting plate body (1) are recessed inward, and the four corners of the mounting plate body (1) are respectively provided with mounting screw holes (11); surface structures of the fuel oil tank body (2) are all retracted to the edge of the mounting plate body (1); a gear pump mounting groove is integrally formed in the lower part on the inner side of the fuel oil tank body (2); an opening of the gear pump mounting groove is formed in the other side of the mounting plate body (1); and the gear pump assembly (3) is mounted in the gear pump mounting groove.

9. The integrated auxiliary fuel oil tank for the vehicle according to claim 1, wherein the coarse filter comprises a coarse filter mounting groove (4) which is integrally formed in the fuel oil tank body (2) on one side of the gear pump mounting groove; a coarse filter core is mounted in the coarse filter mounting groove (4); the coarse filter mounting groove (4) is tilted; an opening of the coarse filter mounting groove (4) is located in the lower part on one side of the fuel oil tank body (2); an end cover (41) is mounted at the opening of the coarse filter mounting groove (4); a fuel oil outlet passage A (42) and a fuel oil outlet passage B (43) which are erected are integrally formed at the top end of the coarse filter mounting groove (4) and a part of the coarse filter mounting groove (4) close to the bottom end on the outer side, respectively; and a port at the top end of the fuel oil outlet passage A (42) or the fuel oil outlet passage B (43) is externally connected to the engine fuel oil system through a pipeline.

10. A method for controlling the integrated auxiliary fuel oil tank for the vehicle according to claim 5, comprising the following steps:
when it is necessary to actively supply fuel oil to the engine fuel oil system from the fuel oil tank body (2), the gear pump assembly (3) is reversed, wherein the fuel oil is fed from the second inlet/outlet and discharged from the third inlet/outlet; the check valve A (211) and the check valve B (231) are closed, and the pressure opening valve (31) is opened, wherein the fuel oil sequentially flows through the intermediate fuel oil passage (22), the gear pump assembly (3), the pressure opening valve (31), the engine fuel oil suction passage (21) and the coarse filter into the engine fuel oil system;
when the vehicle is driving normally and the fuel oil in the fuel oil tank body (2) is sufficient, that is, when the float level gauge (6) does not reach the low liquid level point, the engine fuel oil system actively sucks the fuel oil, and the gear pump assembly (3) does not work; the check valve A (211) is opened, and the check valve B (231) and the pressure opening valve (31) are closed, wherein the fuel oil sequentially flows through the engine fuel oil suction passage (21) and the coarse filter and is then conveyed into the engine fuel oil system; and
when the vehicle is driving normally but the fuel oil in the fuel oil tank body (2) is insufficient, that is, when the float level gauge (6) reaches the low liquid level point, the fuel oil is replenished from the main fuel oil tank of the vehicle; the gear pump assembly (3) rotates forward, wherein the fuel oil is fed from the first inlet/outlet and discharged from the second inlet/outlet; and the check valve A (211) is opened, the pressure opening valve (31) is closed, and the check valve B (231) is opened, wherein the replenished fuel oil is conveyed from the main fuel oil tank of the vehicle, and sequentially flows through the fuel oil replenishing passage (23), the check valve B (231), the gear pump assembly (3), and the intermediate fuel oil passage (22) into the fuel oil tank body (2) until the float level gauge (6) reaches the high liquid level point.
